(19) United States
(12) Patent Application Publication
(10) Pub. No.: US 2026/0264440 A1
(43) Pub. Date: Sep. 10, 2026

(54) A METHOD AND SYSTEM FOR PRINTING ON BONDED FILM MATERIALS HAVING AT LEAST A LAYER OF CONDUCTIVE MATERIAL WITH A DRYING OF INK USING IRRADIATION WITH ELECTRON BEAMS (E-BEAMS)

(71) Applicant: OMET S.R.L., LECCO (LC) (IT)

(72) Inventors: Stefano CASTAGNA, MOLTENO (LC) (IT); Carmine CIOFFI, OGGIONO (LC) (IT); Stefano FRIGERIO, CANZO (CO) (IT)

(73) Assignee: OMET S.R.L., LECCO (LC) (IT)

(21) Appl. No.: 19/166,863

(22) PCT Filed: Mar. 21, 2024
(86) PCT No.: PCT/IB2024/052711

§ 371 Date: Sep. 18, 2025

(30) Foreign Application Priority Data
Mar. 30, 2023 (IT) 102023000006156

(51) Int. Cl. B41M 7/00; B26D 1/14; B31B 70/18; B31B 70/74; B31B 70/88; B31B 155/00; B41F 13/02; B41F 13/58; B41F 23/04; B41M 1/26

(52) U.S. Cl. CPC B41M 7/0081; B26D 1/141; B41F 13/02; B41F 13/58; B41F 23/0406; B41M 1/26; B31B 70/18; B31B 70/76; B31B 70/88; B31B 2155/00

(57) ABSTRACT

The method for printing on bonded film materials includes providing a bonded film material wound in a reel and including a layer of conductive material interposed between at least two layers of insulating material; predisposing a printing line, for printing the bonded film material, in which the printing line includes a drying station of the ink by irradiation of electron beams. The method includes predisposing a conductive contact element having a cutting profile and a ground connection plant connected, on one side to the conductive contact element, and on the other side to the ground surface. The method includes using the conductive contact element for cutting the bonded film material, using the part having a cutting profile to contact the conductive material to place it in contact with the ground connection plant or discharging, to the ground surface, electrostatic loads which may have accumulated in the bonded film material.

### FIELD OF THE INVENTION

The present invention relates to the technical sector concerning the printing on bonded materials in the form of flexible film, obtained from coupling by adhesion of two or more band materials to form a flexible film having a plurality of layers, of which at least one layer is made of a conductive material, for example aluminium, which is interposed between layers of insulating material, such as for example plastic materials, such as PET, PE, PP and so on.

In particular, the present invention can find preferable use, but not for this reason exclusively, in printing processes on flexible bonded film materials, having at least a layer of conductive material having a barrier effect which is interposed between at least two layers of insulating material, and which will be used for realising packaging articles for food products, such as for example pouches (doypacks) for containing food products that are liquids, creamy, in powder form, and so on.

### DESCRIPTION OF THE PRIOR ART

The flexible bonded film materials used for realising packaging articles, such as for example containers or pouches, destined to contain and package food products, must be realised in such a way as to have at least a layer of material having a barrier effect against passage of light, or other external agents of possible contamination of the food products, interposed between layers of materials of insulating type and suitable to be placed in contact with the food products.

Usually the materials that are used to have a barrier effect are conductive, such as for example aluminium.

In this regard, a commonly used technique for realising the flexible bonded film materials includes mutual coupling, by adhesion using adhesive substances, of bands of insulating material, such as for example PET (polyethylene terephthalate), PP (polypropylene), or PE (polyethylene) and at least a band of conductive material, for example aluminium, in such a way as to obtain a multilayer film in which the band of conductive material is interposed between at least two tapes of insulating material.

A first outer layer of the bonded film material, once the film has been processed to obtain a relative packaging article, such as, for example, a pouch, will constitute the internal part of the packaging article, and is therefore destined to go into contact with the food product, while a second outer layer of the bonded film material will go to constitute the external part of the packaging article, visible to the consumer, on which all the images and/or information will be located relative to the food product.

Before carrying out the cutting operations of the bonded film material and the steps of forming the packaging article, it is therefore necessary to proceed to printing all the information and/or images relative to the food products which will have to be packaged on one of the two outer layers of the bonded film material which will go to constitute the external part of the packaging article.

A known technique includes carrying out a first coupling process, for adhesion by application of adhesive substances, of a first band of insulating material with a conductive barrier material band and left to “cure”, i.e. left for a time necessary for the adhesive substances applied to harden to realise the coupling between the two bands, in such a way as to obtain a first semi-finished film article.

Then, using a second band of insulating material printing operations are carried out and then, once the ink used has dried, a second coupling process will be performed, for adhesion by application of adhesive substances, of the second band of printed material with the first semi-finished film article, at the layer of conductive material.

Once the coupling has been carried out, in this case too it will be necessary to wait for the time necessary for the adhesive substances applied to harden to obtain the final and finished bonded film material to be used for realising packaging articles for food products.

To carry out the above-described operations, it will further be necessary to take into consideration the fact that the various band materials will have to be unwound from relative reels and, once the coupling and/or printing operations have been carried out, then be rewound on corresponding other reels.

It is clear that these modalities require a considerable amount of time to complete, which impacts on productivity, and also need adequate storage spaces both for the reels, on which the semi-finished film material is wound, and for the reels on which the insulating material band is wound on which the printing operations are to be carried out, as well as the reels on which the final bonded material is to be wound, following the coupling of the band of insulating material once having been subjected to the printing process, with the semi-finished film material.

An attempt to obviate the above-indicated issues has been to proceed preliminarily to the complete realisation of the finished bonded film material, having at least a layer of conductive material interposed between at least two layers of insulating material and storing it in a relative reel, and using the bonded film material directly in a printing line that has been implemented with a drying station of the ink using irradiation with electron beams, known by the name of E-Beams (Electron Beams).

In this regard, the printing line is made in such a way as to comprise: an initial unwinding station, which is provided with a first reel holder shaft for receiving a first reel of the bonded film material, and which is configured to unwind the bonded film material from the first reel and to advance the bonded film material according to an advancement direction;
a series of printing stations, arranged consecutively to the initial unwinding station and, in succession, the other stations along the advancement direction of the bonded film material, configured to carry out printing processes on an outer layer of the bonded film material during the advancement thereof along the advancement direction;
a drying station (A) by means of irradiation of electron beams (EBeam), arranged downstream of the series of printing stations and along the advancement direction, configured to be crossed by the bonded film material and to irradiate the outer layer on which the printing processes have been carried out so as to dry the ink printed thereon,
a final winding station, comprising a second reel holder shaft, arranged downstream of the drying station and configured to wind the bonded film material in outlet from the drying station about the second reel holder shaft and thus form a second reel of printed bonded film material, therefore also ready to be subjected to successive processing operations, for example for realising packaging articles for food products.

In printing processes with conventional technologies of bonded material, for example with solvent-or water-based, or possibly UV inks, the printing is always protected by a subsequent lamination with protective material, given the poor mechanical and thermal resistance characteristics of traditional inks. The traditional printing process of the bonded material is expensive in terms of work operations, with the printing requested by the customer finalising the product which must necessarily be protected by a further coupling of protective material, leading to the need to allow the bonded material to cure in order to be suitable for the subsequent production steps of the packaging.

Using a drying process by means of irradiation of electron beams (EBeam), given the high mechanical and thermal characteristics obtained by the E-beam inks printed on bonded material, much higher than the traditional printing technologies, the final process of lamination is thus superfluous and not necessary.

By avoiding a final lamination in the process allows the following advantages: faster completion of orders, avoidance of the curing process following printing; reduction of stores for material already ordered by the customer; production of the bonded material is totally independent of the final printing step requested by the customer.

The use of a drying station using a radiation technology with electron beams enables obtaining drying and polymerisation of the ink that is substantially instantaneous, and further also enables using solvent-free or photoinitiator inks, which are especially apt and suitable to be used for printing on bonded film materials destined for realising packaging articles of products for food use. Further, the fact of directly using a bonded film material already final and completed, enables avoiding waiting times which were, instead, required when the band of insulating material, once printed, was coupled by means of adhesion to the semi-finished film material to obtain the final bonded film material.

However, a drawback that has emerged relates to the accumulation of electrostatic loads which are generated owing to the irradiation of electron beams on the bonded material because of the presence of the layer of conductive material internal thereof.

This accumulation of electrostatic loads in the bonded material generates a formation of an electrical potential along all the printing line, and the reels of bonded material present in the initial unwinding station and in the final winding station can act as a sort of armature of a condenser, causing the possible onset of electrical discharges, especially when they are set in rotation.

This can lead to a serious risk of electrocution for an operator in charge of managing the printing line, taking into account that high values of accumulation of electrostatic loads can be reached.

Further, the accumulation of electrostatic loads, with the consequent generation of an electrical potential, can cause the formation of parasitic currents with the onset of processes of corrosion on the mechanical parts that make up the printing line, and damage them, as well as the electrical components, such as for example the electrical control units, thus leading to the need to replace them, as well as causing a possible generation of sparks, with a consequent fire risk.

### SUMMARY OF THE INVENTION

The aim of the invention is therefore to provide a method and a system for carrying out the printing on bonded film materials with drying by means of irradiation of electron beams (EBeam) able to obviate the drawbacks set out in the foregoing.

In particular, an aim of the present invention is to provide a method and a system for carrying out the printing on bonded film materials, for example destined for realising packaging articles, such as pouches, for products for food use, with drying of the ink, printed using irradiation of electron beams able to guarantee the safety of the operators and avoid the occurrence of perilous events or situations as a consequence of the accumulation of electrostatic loads.

The above-mentioned aims are attained with a method and a system according to the contents of the claims.

### BRIEF DESCRIPTION OF THE DRAWINGS

The characteristics of the system and method provided by the present invention for carrying out a printing on bonded film materials with drying by irradiation of electron beams (E-Beam) will be set out in the following description with reference to the appended tables of drawings, in which:

FIG. 1 is a schematic lateral view of the system of the invention in a printing line of a bonded film material in its entirety;

FIG. 1A schematically illustrates, and by way of non-limiting example, possible various types of bonded materials to which the invention can be applied;

FIG. 2 is a larger-scale and partially sectioned along a vertical transversal section plane of the detail identified with the letter K of FIG. 1;

FIG. 3 is a schematic perspective view of the components of FIG. 2;

FIGS. 4 and 5 illustrate, in respective section views along vertical transversal section planes, two possible elements of the system of the invention;

FIG. 6 is a perspective view of other special components which can be present in the system of the invention, according to a possible embodiment;

FIG. 7 is a frontal view of FIG. 6;

FIG. 8 is a view in partial vertical transversal section view of what is illustrated in FIG. 6;

FIG. 9 is a schematic perspective view of further and other special components which can be present in the system of the invention, in a further embodiment;

FIG. 10 is a section view along a vertical transversal section plane of the components of FIG. 9.

The method of the present invention, for printing on bonded film materials having at least a layer of conductive material with a drying of the ink using irradiation with electron beams comprises providing a bonded film material (F) having at least a layer of conductive material (F1), for example, but not exclusively, made of aluminium, which is interposed between at least two layers of insulating material (F2, F3), made, for example, but not exclusively, of a plastic material, such as for example PTE, PPE, PE.

### DESCRIPTION OF PREFERRED EMBODIMENTS

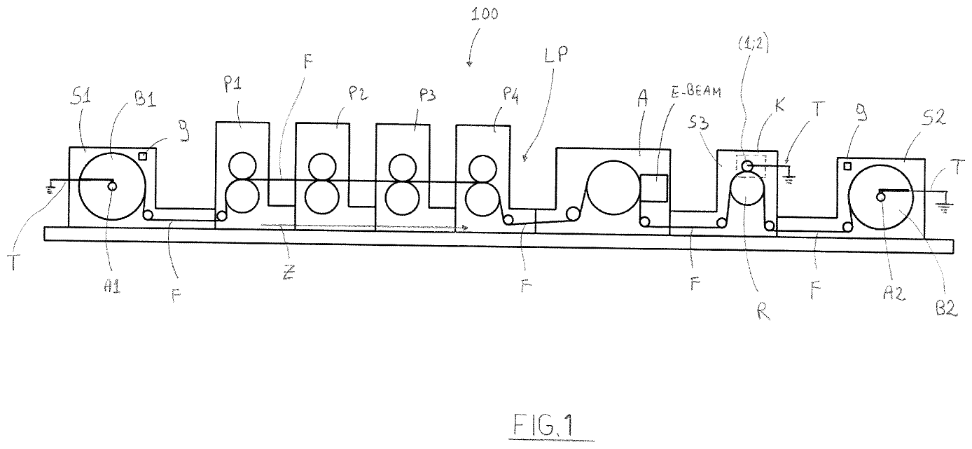

For example, FIG. 1A illustrates four possible, though not exclusive, possible types of bonded film material utilisable with the method of the invention.

For example, a first type of bonded material (M1) that can be used with the method of the invention can be made in such a way as to comprise a layer of conductive material (F1) interposed between a first layer of insulating material (F2) and a second layer of insulating material (F3) (first image, from above, of FIG. 1A).

In this case, the two layers of insulating material (F2, F3) constitute the outer layers of the bonded film material (F) which is wound in a reel (B1).

A second possible type of bonded material (M2) that can be used with the method of the invention can be made in such a way as to comprise a layer of conductive material (F1) interposed between a first layer of insulating material (F2) and a second layer of insulating material (F3), and a further layer of conductive material (F4) external of the second layer (or first layer) of insulating material (F3) (second image from above of FIG. 1A).

In this case, the bonded material will have an outer layer made of insulating material and an outer layer made of conductive material.

A third possible type of bonded material (M3) that can be used with the method of the invention can be made in such a way as to comprise a layer of conductive material (F1) interposed between a first layer of insulating material (F2) and a second layer of insulating material (F3), a further layer of conductive material (F5) adjacent to the preceding layer and also comprised between the first (F2) and second (F3) layer of insulating material, and a third layer of conductive material (F6) external of the second layer (or first layer) of insulating material (F3) (third image from above of FIG. 1A).

In this case, the bonded material will have both outer layers made of insulating material.

A fourth possible type of bonded material (M4) that can be used with the method of the invention can be made in such a way as to comprise a layer of conductive material (F1) interposed between a first layer of insulating material (F2) and a second layer of insulating material (F3), a second layer of conductive material (F7) external of the second layer of insulating material (F2), and a third layer of conductive material (F8) external of the second layer of insulating material (F3) (final image, from below, of FIG. 1A).

In this case, the bonded material will have both outer layers made of conductive material.

The method then includes predisposing a printing line (LP), which is configured for printing, on the bonded film material (F), positioned at least at a respective outer layer.

For example, in the cases of bonded film materials made as in the first type of bonded material (M1) or as in the third type of bonded material (M3) (first and third image of FIG. 1A), the printing will take place on one of the two outer layers of insulating material.

In the remaining two cases, as illustrated in FIG. 1A, the second type of bonded material (M2) or the fourth type of bonded material (M4) (second and fourth image of FIG. 1A) the printing can be carried out on either an outer layer of insulating material or on an outer layer of conductive material.

The printing line (LP) is made and configured in such a way as to comprise:
an initial unwinding station (S1), which is provided with a first reel holder shaft (A1) for receiving a reel (B1) of the bonded film material (F), wherein the printing line (LP) is configured to unwind the bonded film material (F) from the reel (B1) and to advance the bonded film material (F) according to an advancement direction (Z);
a series of printing stations (P1, P2; P3; P4), which are arranged consecutively to the initial unwinding station (S1) and, in succession to one another, along the advancement direction (Z) of the bonded film material (F), and which are configured to carry out printing processes on an outer layer of the bonded film material (F) during the advancement thereof along the advancement direction (Z).

By “a series of printing stations” is meant the sufficient number of printing stations for carrying out the prints requested, so the printing line could also be realised to be provided with one printing station alone.

The printing line (LP) is made in such a way as further to comprise: a drying station (A) by means of irradiation of electron beams (EBeams), arranged downstream of the series of printing stations (P1, P2, P3, P4), and which is provided with a module for emitting electron beams (E-Beam module) and configured to be crossed by the bonded film material (F) and to irradiate, with the electron beams, the outer layer on which the printing processes have been carried out so as to dry the ink printed thereon,
a final winding station (S2), comprising a second reel holder shaft (A2, arranged downstream of the drying station (A) and configured to wind the bonded film material (F) in outlet from the drying station (A) about the second reel holder shaft (A2) and thus form a second reel (B2) of printed bonded film material (F).

The special characteristics of the method of the present invention consist in the fact that it comprises:
arranging at least a conductive contact element (1, 2) which is conformed in such a way as to comprise at least a part having a cutting profile (10, 20); predisposing a ground connection plant (T) connected, on one side to the at least a conductive contact element (1, 2), and on the other side to the ground surface;
then using the at least a part having a cutting profile (1; 2) of the conductive contact element (10, 20) to at least partially cut the bonded film material (F) in such a way that the at least a part having a cutting profile (10; 20) reaches into contact with the at least a layer of conductive material (F1) of the bonded film material (F).

According to the method, the part having a cutting profile must reach into contact with the most internal layer of conductive material present in the bonded film material.

In this way, and advantageously, the at least a layer of conductive material (F1) is placed directly in contact with the ground connection plant (T) for discharging to the ground surface any electrostatic loads that may accumulate in the bonded film material (F) following irradiation via the electron beams in the drying station.

Owing to these special characteristics, with the method of the invention it is therefore possible to prevent accumulation of electrostatic loads that can generate sparks or be the cause of electrocution or wear on the mechanical components and/or the electrical components (for example electrical control units) of the printing line, as the electrostatic loads are discharged directly to the earth via the ground connection plant (T) which is placed in communication with the at least a layer of conductive material (F1) of the bonded film material (F) by means of the incision made by the conductive contact element via the at least a part having a cutting profile.

The method of the invention therefore enables resolving the drawbacks present in the prior art inherent in the long waiting times and the management of the storage of the reels, in a case where the printing operations are carried out with the classical method, as well as obviating the issues existing in the printing lines which use the ink drying process by means of radiation of electron beams as an eventual accumulation of electrostatic discharges can be discharged directly to the ground surface, enabling operators to work in total safety and significantly reducing the times for completion of the printing process.

Further advantageous aspects of the method of the invention are described in the following.

In a preferred aspect, the method comprises predisposing the at least a conductive contact element (1, 2) in an operating station (S3) situated downstream or upstream of the drying station (A), for example, in a preferred though not exclusive way, as illustrated in FIG. 1, between the drying station (A) and the final winding station (S2), and using the at least a part having a cutting profile (10; 20) of the conductive contact element (1, 2) to at least partially score the bonded film material (F) during the advancement of the bonded film material (F) through the operating station (S3).

The method preferably comprises predisposing a contrast roller (R) in the operating station (S3) and partially winding the bonded film material (F) about the contrast roller (R) and wherein the at least a conductive contact element (1, 2) is predisposed in such a way that the at least a part having a cutting profile (10, 20) is arranged opposite the contrast roller (R) to at least partially score the bonded film material (F) during the partial winding thereof about the contrast roller (R).

In a further preferred aspect, the method of the invention can comprise predisposing a conductive contact element (1, 2) conformed as a circular cutter (1) with a continuous cutting profile (10) and using the circular cutter (1) having a continuous cutting profile (10) to cut and laterally trim, on both sides, the bonded film material (F) during the partial winding thereof about the contrast roller (R), in such a way that the continuous cutting profile (10) of the circular cutter (1) is in contact with the at least a layer of conductive material (F1) of the bonded film material (F).

On the basis of a further possible preferred aspect, the method of the invention can comprise predisposing a conductive contact element (1, 2) having a circular cutter profile (2) with a discontinuous cutting profile (20) and using the circular cutter (2) having a discontinuous cutting profile (20) to partially score the bonded film material (F) during the partial winding thereof about the contrast roller (R), in such a way that the discontinuous cutting profile (20) of the circular cutter (2) is in contact with the at least a layer of conductive material (F1) of the bonded film material (F).

With the aim of making more secure and efficient the discharge to the ground surface of the electrostatic loads which may accumulate in the bonded film material, and which can propagate along the bonded film material, the method of the invention can also comprise following further advantageous aspects.

The method of the invention can comprise predisposing at least a second conductive contact element (5, 6) which is conformed in such a way as to comprise at least a sharp portion (50, 60), wherein the at least a second conductive contact element (5, 6) is coupled to the ground connection plant (T) and is coupled to at least the first reel holder shaft (A1), in the initial unwinding station (S1), and/or to the second reel holder shaft (A2), in the final winding station (S2), in such a way that the at least a sharp portion (50, 60) is facing towards the reel (B1, B2) of bonded film material (F) in such a way as to at least partially penetrate into the bonded film material (F) in such a way as to go into contact with the at least a layer of conductive material (F1).

In this way, it is possible to create a direct contact with the ground connection plant, and therefore have a ground surface discharge of the electrostatic loads, including directly at the reel holder shafts.

Further, the presence of the at least a second conductive contact element (5, 6), which is directly coupled to the reel holder shaft, enables also scoring, by means of the at least a sharp portion (50., 60), the joints that are realised between two portions of bonded film material, when a first portion of bonded film material has been completely unwound from a relative reel, which is removed from the reel holder shaft, and which must be united and joined to a second portion of bonded film material that is wound on a relative reel that is to be mounted on the reel holder shaft to guarantee the continuity of the printing process.

In a preferred aspect, the method of the invention can comprise using at least a second conductive contact element (5, 6) is conformed in a blade shape (5) and wherein the at least a sharp portion (50, 60) comprises a series of sharp serrations (50), wherein the blade (5) is axially mounted on the first reel holder shaft (A1) and/or axially on the second reel holder shaft (A2) in such a way that the series of sharp serrations (50) project radially from the first reel holder shaft (A1) and/or from the second reel holder shaft (A2) in such a way as to transversally score the reel (B1, B2) of printed bonded film material (F) with the sharp serrations (50) going into contact with the at least a layer of conductive material (F1) of the bonded film material (F).

On the basis of a further other preferred aspect, the method of the invention can comprise using at least a second conductive contact element (5, 6) which is conformed as a ring (6) wherein the at least a sharp portion (50, 60) comprises a series of sharp wedge-shaped elements (60) projecting from the ring (6), wherein the ring (6) is coaxially mounted on the first reel holder shaft (A1) and/or coaxially to the second reel holder shaft (A2), in such a way that the sharp wedge-shaped elements (60) are axially arranged with respect to the first reel holder shaft (A1) and/or to the second reel holder shaft (A2) and facing towards the reel (B1, B2) of bonded film material (F) in such a way as to transversally score the reel (B1, B2) of printed bonded film material (F) with the sharp wedge-shaped elements (60) going into contact with the at least a layer of conductive material (F1) of the bonded film material (F).

The appended figures illustrate the system (100) for printing on bonded film materials which is realised and configured to carry out and actuate the method of the invention.

The system (100) is suitable for carrying out a print on bonded film materials having at least a layer of conductive material with a drying of ink using irradiation using electron beams, wherein the bonded film material (F) comprises at least a layer of conductive material (F1), for example but not limitedly to aluminium, interposed between at least two layers of insulating material (F2, F3), for example but not exclusively to a plastic material, such as PTE, PE, PPE, and arranging the bonded film material wound in a reel (B1).

The types of bonded material utilisable in the system of the invention can be, in a preferred though not exclusive way, for example those described in the foregoing, and illustrated in FIG. 1A.

The system (100) comprises a printing line (LP), for printing the bonded film material (F) positioned at least at a respective outer layer.

The printing line (LP) is made in such a way as to comprise (see for example FIG. 1):
an initial unwinding station (S1), which is provided with a first reel holder shaft (A1) for receiving a reel (B1) of the bonded film material (F), wherein the printing line (LP) is configured to unwind the bonded film material (F) from the reel (B1) and to advance the bonded film material (F) according to an advancement direction (Z);
at least a printing station, preferably a series of printing stations (P1, P2, P3, P4), arranged consecutively to the initial unwinding station (S1) and, in succession to one another, along the advancement direction (Z) of the bonded film material (F), configured to carry out printing processes on an outer layer of the bonded film material (F) during the advancement thereof along the advancement direction (Z);
a drying station (A) by means of irradiation of electron beams (EBeam), arranged downstream of the series of printing stations (P1, P2, P3, P4), configured to be crossed by the bonded film material (F) and to irradiate the outer layer on which the printing processes have been carried out so as to dry the ink printed thereon,
a final winding station (S2), comprising a second reel holder shaft (A2, arranged downstream of the drying station (A) and configured to wind the bonded film material (F) in outlet from the drying station (A) about the second reel holder shaft (A2) and thus form a second reel (B2) of printed bonded film material (F).

The peculiarities of the system (100) consist in the fact that it further comprises:
at least a conductive contact element (1, 2) conformed in such a way as to comprise at least a part having a cutting profile (10, 20);
a ground connection plant (T) connected, on one side, to the at least a conductive contact element (1, 2), and on the other side to the ground surface.

In greater detail, the conductive contact element (1, 2) is configured and activatable to at least partially cut, using the at least a part having a cutting profile (10, 20) the bonded film material (F) in such a way that the part having a cutting profile (10, 20) reaches into contact with the at least a layer of conductive material (F1) of the bonded film material (F) in such a way that the at least a layer of conductive material (F1) is in contact with the ground connection plant (T) for discharging, to the ground surface, electrostatic loads which may have accumulated in the bonded film material (F).

The system is configured in such a way that the part having a cutting profile of the contact element reaches into contact with the most internal layer of conductive material present in the bonded film material.

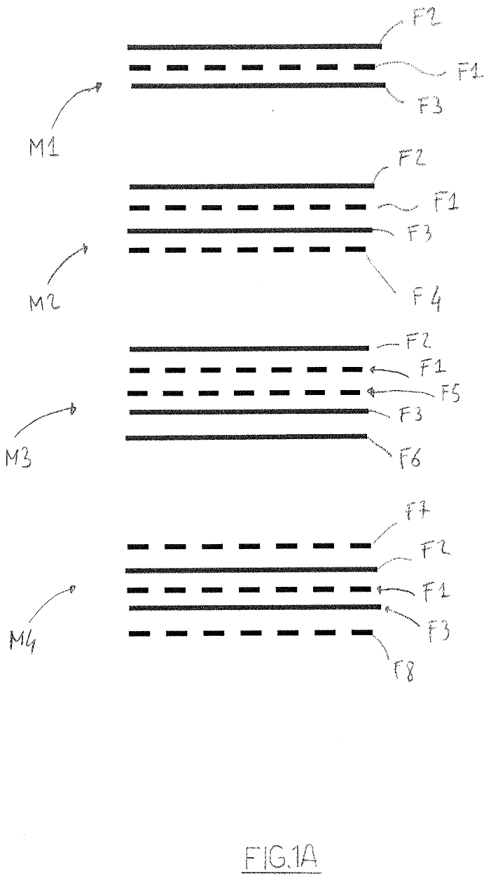

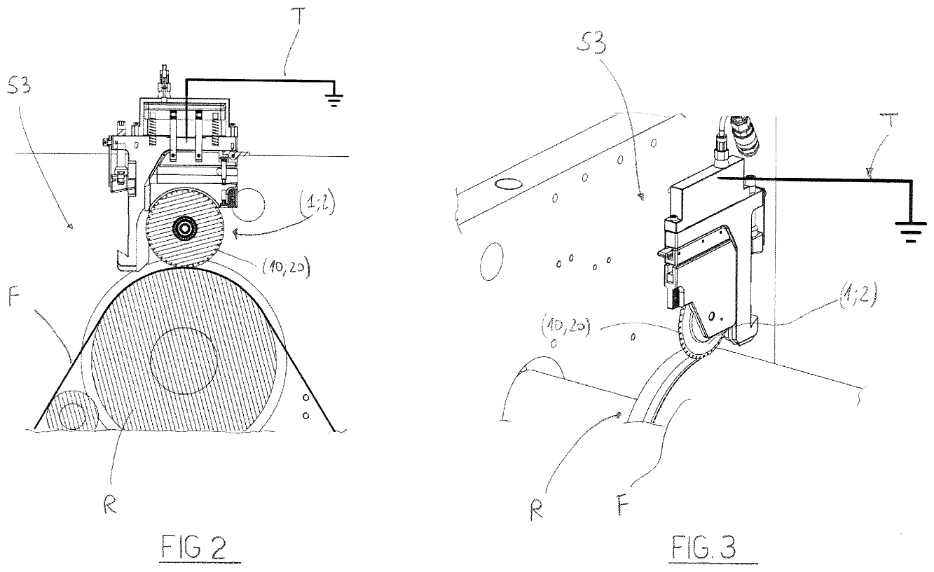

On the basis of a further possible preferred aspect, the system (100) can comprise an operating station (S3) (see in particular FIGS. 2 and 3) which can be situated upstream or downstream of the drying station (A), for example, in a preferred though not exclusive way, in FIG. 1, between the drying station (A) and the final winding station (S2), wherein the at least a conductive contact element (1, 2) is arranged and situated internally of the second operating station (S3) and is configured to be activatable in such a way that the at least a part having a cutting profile (10, 20) of the conductive contact element (1, 2) goes into contact with and at least partially scores the bonded film material (F) during the advancement of the bonded film material (F) through the operating station (S3).

In this case, the system (100) preferably comprises a contrast roller (R) arranged in the operating station (S3) and configured to partially wind the bonded film material (F) about it, and wherein the at least a conductive contact element (1, 2) is arranged in the operating station (S3) in such a way that the at least a part having a cutting profile (10, 20) is arranged opposite the contrast roller (R) so as to at least partially score the bonded film material (F) during the partial winding thereof about the contrast roller (R).

On the basis of another advantageous aspect, the system (100) can comprise a conductive contact element (1, 2) which is conformed as a circular cutter (1) having a continuous cutting profile (10) (FIG. 5), wherein the circular cutter (1) having a continuous cutting profile (10) is arranged and activatable to cut and laterally trim, on both sides, the bonded film material (F) during the partial winding thereof about the contrast roller (R), in such a way that the continuous cutting profile (10) of the circular cutter (1) is in contact with the at least a layer of conductive material (F1) of the bonded film material (F).

Further, additionally or alternatively, the system (100) can comprise a conductive contact element (1, 2) which is conformed as a circular cutter (2) having a discontinuous cutting profile (20) (FIG. 4), wherein the circular cutter (2) having a discontinuous cutting profile (20) is arranged and activatable in order to partially score the bonded film material (F) during the partial winding thereof about the contrast roller (R), in such a way that the discontinuous cutting profile (20) of the circular cutter (2) is in contact with the at least a layer of conductive material (F1) of the bonded film material (F).

The system (100) can be made in such a way as to comprise only the circular cutter (1) having a continuous cutting profile (10) or only the circular cutter (2) having a discontinuous cutting profile (20), or both.

The system (100) can also be made in such a way as to comprise at least a second conductive contact element (5, 6) which is conformed in such a way as to comprise at least a sharp portion (50, 60), wherein the at least a second conductive contact element (5, 6) is connected to the ground connection plant (T) and is coupled to at least the first reel holder shaft (A1), in the initial unwinding station (S1), and/or to the second reel holder shaft (A2), in the final winding station (S2), in such a way that the at least a sharp portion (50, 60) is facing towards the reel (B1, B2) of bonded film material (F) in such a way as to at least partially penetrate into the bonded film material (F) in such a way as to go into contact with the at least a layer of conductive material (F1).

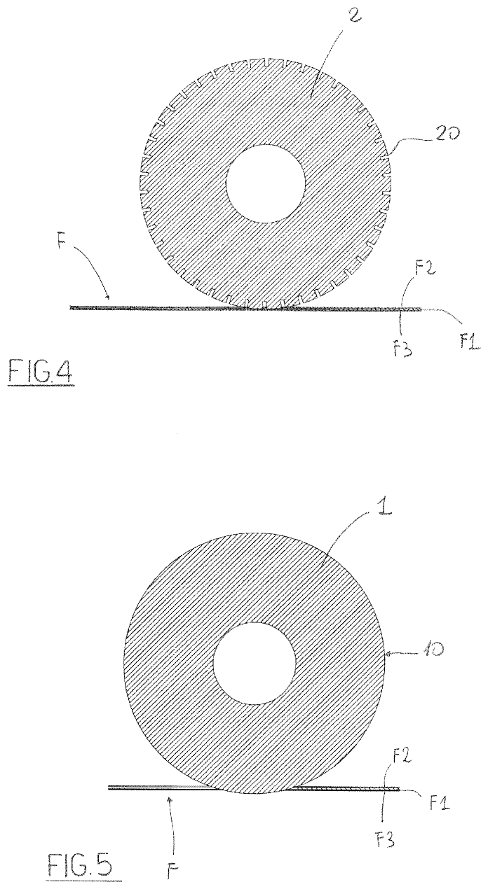

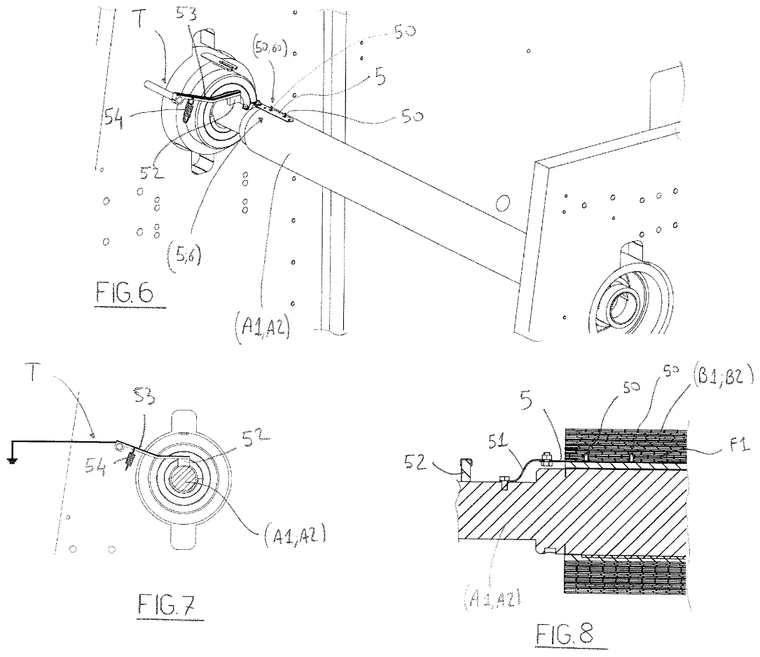

On the basis of a preferred aspect (see for example FIGS. 6, 7, 8), the at least a second conductive contact element (5, 6) can be conformed in a blade shape (5) and the at least a sharp portion (50, 60) comprises a series of sharp serrations (50).

In this case, the blade (5) is axially mounted on the first reel holder shaft (A1) and/or axially on the second reel holder shaft (A2) in such a way that the series of sharp serrations (50) project radially from the first reel holder shaft (A1) and/or from the second reel holder shaft (A2) in such a way as to transversally score the reel (B1, B2) of printed bonded film material (F) with the sharp serrations (50) going into contact with the at least a layer of conductive material (F1) of the bonded film material (F).

For the connection with the ground connection plant (T), the blade (5) comprises a portion of conductive contact (51) which is connected to a part of the reel holder shaft (A1, A2) and a dragging contact element (52) is predisposed, which, by means of a rod (53), made of a conductive material, pushed by a spring (54), is maintained in contact with the reel holder shaft (A1, A2), with the rod (53) being connected to the ground connection plant (T) (see again for example FIGS. 6, 7, 8).

In a further possible preferred aspect, the system (100) can be made in such a way that the at least a second conductive contact element (5, 6) is conformed in a ring shape (6) and wherein the at least a sharp portion (50, 60) comprises a series of sharp wedge-shaped elements (60) projecting from the ring (6).

In this case, the ring (6) is coaxially mounted on the first reel holder shaft (A1) and/or coaxially to the second reel holder shaft (A2, in such a way that the sharpened wedge-shaped elements (60) are axially arranged with respect to the first reel holder shaft (A1) and/or to the second reel holder shaft (A2 and facing towards the reel (B1, B2) of bonded film material (F) in such a way as to transversally score the reel (B1, B2) of printed bonded film material (F) with the sharp wedge-shaped elements (60) going into contact with the at least a layer of conductive material (F1) of the bonded film material (F).

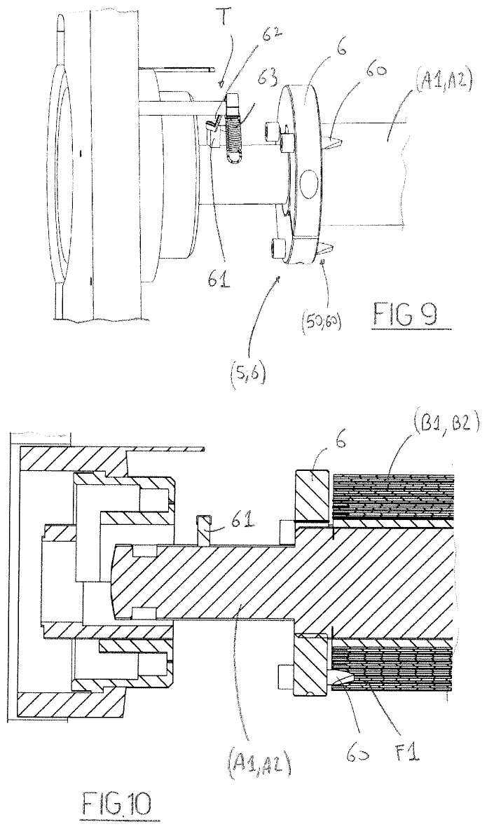

For the connection with the ground connection plant (T), the ring (6), realised in a conductive material, is mounted coaxially and in contact with the reel carrier shaft (A1, A2), and a dragging contact (61) is predisposed and is maintained in contact with a portion of the reel holder shaft (A1, A2) by an arm (62), made of conductive material, pushed by a spring (63), with the arm (62) being connected to the ground connection plant (T) (see for example FIG. 9). The system (100) can also comprise appropriate detection sensors (9), for example arranged in the unwinding station (S1) and/or in the winding station (S2), or also in any other position along the printing line (LP), which are configured to detect and identify any leakages of electrical charges in such a way as to provide a warning signal, or to intervene to block the printing line.

1) A method for printing on bonded film materials having at least a layer of conductive material with a drying of ink using irradiation with electron beams, comprising:
providing a bonded film material comprising at least a layer of conductive material interposed between at least two layers of insulating material, and arranging the bonded film material wound in a reel;
predisposing a printing line, for printing the bonded film material at least at a respective outer layer,
wherein the printing line comprises:
an initial unwinding station, which is provided with a first reel holder shaft for receiving the reel of the bonded film material, wherein the printing line is configured to unwind the bonded film material from the reel and to advance the bonded film material according to an advancement direction;
a series of printing stations, arranged consecutively to the initial unwinding station and, in succession, the other stations along the advancement direction of the bonded film material, configured to carry out printing processes on an outer layer of the bonded film material during the advancement thereof along the advancement direction;
a drying station by means of irradiation of electron beams (EBeam), arranged downstream of the series of printing stations, configured to be crossed by the bonded film material and to irradiate the outer layer thereof on which the printing processes have been carried out so as to dry the ink printed thereon;
a final winding station, comprising a second reel holder shaft, arranged downstream of the drying station and configured to wind the bonded film material in outlet from the drying station about the second reel holder shaft and form a second reel of printed bonded film material;
the method being characterised in that it comprises:
predisposing at least a conductive contact element conformed in such a way as to comprise at least a part having a cutting profile;
predisposing a ground connection plant connected, on one side to the at least a conductive contact element, and on the other side to the ground surface;
using the conductive contact element to at least partially score the bonded film material by means of the at least a part having a cutting profile in such a way that the part having a cutting profile reaches into contact with the at least a layer of conductive material of the bonded film material in such a way that the at least a layer of conductive material is in contact with the ground connection plant for discharging, to the ground surface, electrostatic loads which may have accumulated in the bonded film material.

2) The method as claimed in claim 1, comprising predisposing the at least a conductive contact element in an operating station situated upstream or downstream of the drying station, and using the at least a part having a cutting profile of the conductive contact element to at least partially score the bonded film material during the advancement of the bonded film material through the operating station.

3) The method as claimed in claim 2, comprising predisposing a contrast roller in the operating station and partially winding the bonded film material about the contrast roller and wherein the at least a conductive contact element is predisposed in such a way that the at least a part having a cutting profile is arranged opposite the contrast roller in order to at least partially score the bonded film material during the partial winding thereof about the contrast roller.

4) The method as claimed in claim 3, comprising predisposing a conductive contact element conformed as a circular cutter having a continuous cutting profile and using the circular cutter having a continuous cutting profile to cut and laterally trim, on both sides, the bonded film material during the partial winding thereof about the contrast roller, in such a way that the continuous cutting profile of the circular cutter is in contact with the at least a layer of conductive material of the bonded film material.

5) The method as claimed in claim 3, comprising predisposing a conductive contact element conformed as a circular cutter profile with a discontinuous cutting profile and using the circular cutter having a discontinuous cutting profile to partially score the bonded film material during the partial winding thereof about the contrast roller, in such a way that the discontinuous cutting profile of the circular cutter is in contact with the at least a layer of conductive material of the bonded film material.

6) The method as claimed in claim 1, comprising predisposing at least a second conductive contact element which is conformed in such a way as to comprise at least a sharp portion, wherein the at least a second conductive contact element is connected to the ground connection plant, wherein the at least a second conductive contact element is coupled to at least the first reel holder shaft, in the initial unwinding station, and/or to the second reel holder shaft, in the final winding station, in such a way that the at least a sharp portion is facing towards the reel of bonded film material in such a way as to at least partially penetrate into the bonded film material in such a way as to go into contact with the at least a layer of conductive material.

7) The method as claimed in claim 6, wherein the at least a second conductive contact element is conformed as a blade and wherein the at least a sharp portion comprises a series of sharp serrations, wherein the blade is axially mounted on the first reel holder shaft and/or axially on the second reel holder shaft in such a way that the series of sharp serrations project radially from the first reel holder shaft and/or from the second reel holder shaft in such a way as to transversally score the reel of printed bonded film material with the sharp serrations going into contact with the at least a layer of conductive material of the bonded film material.

8) The method as claimed in claim 6, wherein at least a second conductive contact element is conformed as a ring and wherein the at least a sharp portion, comprises a series of sharp wedge-shaped elements projecting from the ring, wherein the ring is coaxially mounted on the first reel holder shaft, and/or coaxially mounted on the second reel holder shaft, in such a way that the sharp wedge-shaped elements are axially arranged with respect to the first reel holder shaft and/or to the second reel holder shaft and facing towards the reel of bonded film material in such a way as to transversally score the reel of printed bonded film material with the sharp wedge-shaped elements going into contact with the at least a layer of conductive material of the bonded film material.

9) A system for printing on bonded film materials having at least a layer of conductive material with a drying of ink using irradiation with electron beams, wherein the bonded film material comprises at least a layer of conductive material interposed between at least two layers of insulating material, and arranging the bonded film material wound in a reel, and wherein the system is configured to carry out the method of claim 1 and comprises:
a printing line, for printing the bonded film material at least at a respective outer layer, wherein the printing line comprises:
an initial unwinding station, which is provided with a first reel holder shaft for receiving a reel of the bonded film material,
wherein the printing line is configured to unwind the bonded film material from the reel and to advance the bonded film material according to an advancement direction;
a series of printing stations, arranged consecutively to the initial unwinding station and, in succession, the other stations along the advancement direction of the bonded film material, configured to carry out printing processes on an outer layer of the bonded film material during the advancement thereof along the advancement direction;
a drying station by means of irradiation of electron beams (EBeam), arranged downstream of the series of printing stations configured to be crossed by the bonded film material and to irradiate the outer layer on which the printing processes have been carried out so as to dry the ink printed thereon;
a final winding station, comprising a second reel holder shaft, arranged downstream of the drying station and configured to wind the bonded film material in outlet from the drying station about the second reel holder shaft and thus form a second reel of printed bonded film material;
the system being characterised in that it comprises:
at least a conductive contact element conformed in such a way as to comprise at least a part having a cutting profile;
a ground connection plant connected, on one side to the at least a conductive contact element, and on the other side to the ground surface;
wherein the conductive contact element is configured and activatable to at least partially score the bonded film material by means of the at least a part having a cutting profile in such a way that the part having a cutting profile goes into contact with the at least a layer of conductive material of the bonded film material so that the at least a layer of conductive material is in contact with the ground connection plant for discharging, to the ground surface, electrostatic loads which may have accumulated in the bonded film material.

10) The system as claimed in claim 9, comprising an operating station situated upstream or downstream of the drying station, wherein the at least a conductive contact element is arranged and situated internally of the second operating station and is configured to be activatable in such a way that the at least a part having a cutting profile of the conductive contact element goes into contact with and at least partially scores the bonded film material during the advancement of the bonded film material through the operating station.

11) The system as claimed in claim 10, comprising a contrast roller arranged in the operating station and configured to partially wind the bonded film material about itself, and wherein the at least a conductive contact element is arranged in the operating station in such a way that the at least a part having a cutting profile is arranged opposite the contrast roller in order to at least partially score the bonded film material during the partial winding thereof about the contrast roller.

12) The system as claimed in claim 11, comprising using a conductive contact element conformed as a circular cutter with a continuous cutting profile, wherein the circular cutter having a continuous cutting profile is arranged and activatable to cut and laterally trim, on both sides, the bonded film material during the partial winding thereof about the contrast roller, in such a way that the continuous cutting profile of the circular cutter is in contact with the at least a layer of conductive material of the bonded film material.

13) The system as claimed in claim 11, comprising using a conductive contact element conformed as a circular cutter with a discontinuous cutting profile, wherein the circular cutter having a discontinuous cutting profile is arranged and activatable to partially score the bonded film material during the partial winding thereof about the contrast roller, in such a way that the discontinuous cutting profile of the circular cutter is in contact with the at least a layer of conductive material of the bonded film material.

14) The system as claimed in claim 9, comprising at least a second conductive contact element which is conformed in such a way as to comprise at least a sharp portion, wherein the at least a second conductive contact element is connected to the ground connection plant, wherein the at least a second conductive contact element is coupled to at least the first reel holder shaft, in the initial unwinding station, and/or to the second reel holder shaft, in the final winding station, in such a way that the at least a sharp portion is facing towards the reel of the bonded film material in such a way as to at least partially penetrate into the bonded film material in such a way as to go into contact with the at least a layer of conductive material.

15) The system as claimed in claim 14, wherein the at least a second conductive contact element is conformed as a blade and wherein the at least a sharp portion comprises a series of sharp serrations, wherein the blade is axially mounted on the first reel holder shaft and/or axially on the second reel holder shaft in such a way that the series of sharp serrations project radially from the first reel holder shaft and/or from the second reel holder shaft in such a way as to transversally score the reel of printed bonded film material with the sharp serrations which go into contact with the at least a layer of conductive material of the bonded film material.

16) The system as claimed in claim 14, wherein at least a second conductive contact element is conformed as a ring and wherein the at least a sharp portion comprises a series of sharp wedge-shaped elements projecting from the ring, wherein the ring is coaxially mounted on the first reel holder shaft, and/or coaxially mounted on the second reel holder shaft, in such a way that the sharp wedge-shaped elements are axially arranged with respect to the first reel holder shaft and/or to the second reel holder shaft and facing towards the reel of bonded film material in such a way as to transversally score the reel of printed bonded film material with the sharp wedge-shaped elements which go into contact with the at least a layer of conductive material of the bonded film material.
